(19) United States
(12) Patent Application Publication
(10) Pub. No.: US 2015/0242512 A1
(43) Pub. Date: Aug. 27, 2015

(54) Systems and Methods for Ranking Search Results Based on User Identification of Items of Interest

(71) Applicant: Google Inc., Mountain View, CA (US)

(72) Inventors: Benjamin A. Lindahl, Mountain View, CA (US); Mat Balez, San Francisco, CA (US); Peter Alexander Broderson Wilson, Albany, CA (US); Kansinee Adsanatham, San Francisco, CA (US)

(73) Assignee: Google Inc., Mountain View, CA (US)

(21) Appl. No.: 13/711,143

(22) Filed: Dec. 11, 2012

(51) Int. Cl. G06F 17/30

(52) U.S. Cl. CPC G06F 17/30867

(57) ABSTRACT

Embodiments include a computer-implemented method that includes receiving a search query associated with a user, identifying a set of search results responsive to the search query, identifying one or more search results of the set of search results that correspond to one or more items previously identified by the user as being of interest to the user, ranking the set of search results to generate a ranked set of search results, the ranking including boosting the rankings of the one or more search results that correspond to one or more items previously identified by the user as being of interest to the user, and providing search result content for display via a graphical user interface, the search result content including the ranked set of search results.

### BACKGROUND OF THE INVENTION

1. Field of the Invention

Embodiments of this invention relate generally to search industries and, more particularly, to special purpose machines, systems, methods and computer instructions for ranking and displaying search results based on items identified by a user.

2. Description of the Related Art

Users employ Internet searches to locate items of interest from the millions of items available on the Internet. For example, a user may submit a search for “Movie theatre” in hopes of locating webpages, maps, and the like that provide information regarding a movie theatre that is near their location. Search results typically include a listing of hyperlinks to the location items on the Internet as well as some information about the search result. The search results are typically displayed in an ordered listing based one the search results relevance to the search query. For example, webpages including content that closely matches the query string may be ranked and displayed higher in the search results listing than other webpages. In some instances, the user's past Internet browsing history may be used to determine the user's preferences/demographics and search results that correspond to the user's preferences/demographics may be ranked higher.

Applicants have recognized that, despite search providers taking measures to gather and interpret information about what the user is interested in, search results may not rank and display search results in accordance with the user's actual interest. As a result, user's may have to expend additional effort in locating items of interest or, in some instances, the user may employ another search provider in hopes of receiving search results that they are interested in.

### SUMMARY OF THE INVENTION

Various embodiments of methods and apparatus for identifying and displaying search results are provided herein. In some embodiments, provided is a computer-implemented method that includes receiving a search query associated with a user, identifying a set of search results responsive to the search query, identifying one or more search results of the set of search results that correspond to one or more items previously identified by the user as being of interest to the user, ranking the set of search results to generate a ranked set of search results, the ranking including boosting the rankings of the one or more search results that correspond to one or more items previously identified by the user as being of interest to the user, and providing search result content for display via a graphical user interface, the search result content including the ranked set of search results.

In some embodiments, provided is a system including one or more memories storing instructions and one or more processors coupled to the one or more memories and executing the instructions stored thereon in order to perform the following steps: receiving a search query associated with a user, identifying a set of search results responsive to the search query, identifying one or more search results of the set of search results that correspond to one or more items previously identified by the user as being of interest to the user, ranking the set of search results to generate a ranked set of search results, the ranking including boosting the rankings of the one or more search results that correspond to one or more items previously identified by the user as being of interest to the user, and providing search result content for display via a graphical user interface, the search result content including the ranked set of search results.

In some embodiments, provided is a computer-implemented method that includes identifying one or more search results responsive to a search query and that correspond to one or more items previously identified by a user as being of interest to the user, the one or more items previously identified by the user as being of interest to the user being associated with a ranking factor, ranking the set of search results to generate a ranked set of search results, the ranking including boosting the rankings of the one or more search results that correspond to one or more items previously identified by the user as being of interest to the user by multiplying scores associated with the one or more search results that correspond to the one or more items previously identified by the user as being of interest to the user by the factor, and providing search result content for display via a graphical user interface, the search result content including the ranked set of search results.

### BRIEF DESCRIPTION OF THE DRAWINGS

FIG. 1 is an illustration of a place page in accordance with one or more embodiments of the present invention.

FIG. 2 is an illustration of a table including a listing of items of interest to a user in accordance with one or more embodiments of the present invention.

FIG. 3 is a flowchart that illustrates a method of ranking and displaying search results in accordance with one or more embodiments of the present invention.

FIG. 4 is an illustration of a table including a listing of ranked search results in accordance with one or more embodiments of the present invention.

FIG. 5 is an illustration of a webpage displaying ranked search results in accordance with one or more embodiments of the present invention.

FIG. 6 is a block diagram that illustrates a search query environment in accordance with one or more embodiments of the present invention.

FIG. 7 is a block diagram that illustrates an exemplary computer system in accordance with one or more embodiments of the present invention.

### DETAILED DESCRIPTION

As discussed in more detail below, provided are systems and methods for ranking and displaying search results. Certain embodiments include a user selecting items that are of interest to them (e.g., places the user would like to visit in the future, articles they would like to read, etc.), and, in response to receiving a search query from the user, generating and displaying a set of search results that reflect the user's interest in the items. In some embodiments, search results that correspond to the selected items receive a boost in ranking such that they appear higher within the set of search results ultimately displayed to the user. For example, where a user selects “The Palo Alto Restaurant” as a place of interest while surfing the Internet, and later submits a search query for “restaurants” that generates a set of search results including “The Palo Alto Restaurant”, the search result for “The Palo Alto Restaurant” receives a boost in its ranking/score such that it is displayed higher within the search results or in another prominent location. Accordingly, search results that correspond to items a user has explicitly expressed an interest in may incur a boost in their rating such that they are displayed more prominently. Thus, for example, a user may be able to select a place they would like to visit in the future (e.g., paces they want to go to) and search results that correspond to the place selected by the user receive a boost in score/ranking within search results that are provided to the user.

In some embodiments, a list of items selected by the user is generated as the user selects various items. When the user submits a search query, search results corresponding to items in the list may be subject to a score enhancement that helps to boost a ranking score or similar metric used to rank the search results. In some embodiments, the score enhancement includes a score multiplier. For example, a ranking score for search results that correspond to items in the list may be subject to a 2.0× factor (i.e., the score is multiplied by two). In some embodiments, items are associated with different levels/degrees of interest and corresponding levels/degrees of score enhancements. For example, ranking scores for items the user selects as being of high interest may be subject to a factor of 2.0×, and ranking scores for items the user selects as being of moderate interest may subject to a factor of 1.5×.

Although certain embodiments are described with regard to a various types of items (e.g., places) for illustrative purposes, similar embodiments may be employed with any variety of items such as webpages, articles, goods, services, etc. For example, a user may select various places (e.g., landmarks, cities, businesses, etc.), webpages, articles, goods, services and so forth, such that search results corresponding to any of the items selected receive a boost in their score/ranking regardless of the type of item.

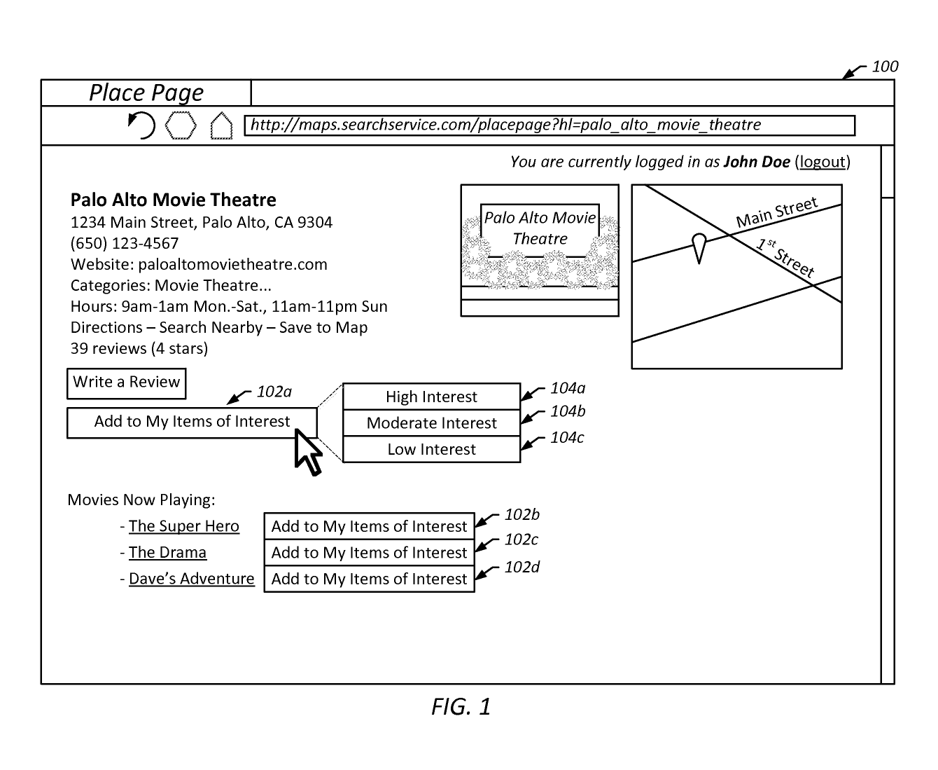

In some embodiments, a user selects items of interest while navigating (“surfing” the Internet. For example, a user selects an icon or similar graphic associated with an item listed on a webpage and the selected item is added to a list of items that are interest to the user. FIG. 1 is an illustration of a place page 100 for “Palo Alto Movie Theatre”. A place-page is a webpage that includes information about a particular geographic place (e.g., a business, point of interest, transit station, neighborhood, landmarks, city and so forth). A place-page often includes contact information for the given place, photographs/images relating to the place, reviews for the place, and so forth. For example, place page 100 may include a place-page for “Palo Alto Movie Theatre” that provides information including a name, address, phone number, webpage, a type/category, hours of operation, directions, reviews, an option to add a review, a listing of movies now playing, a map and so forth. Place page 100 also includes an option to add the place (“Palo Alto Movie Theatre”) to the user's items of interest via selection of button 102a, as well as options to add the individual movies listed to the user's items of interest via selection of buttons 102b, 102c and 102d. Upon user selection of one of the buttons, the corresponding item is added to a list of items that are of interest to a user.

In some embodiments, the option to select an item of interest may be provided within a listing of search results. For example, a search result for a business may be accompanied by a button similar to that of button 102a that can be selected by the user to add the business to the list of items that are of interest to the user. A similar button may be provided in association with any variety of search results such that an item corresponding to the search result is added to a list of items that are of interest to a user upon the user selecting a button corresponding to the search result.

In some embodiments, the selections are associated with the user based on the user identifying them self. For example, the user “John Doe” may log into his account by providing his unique name and password. John Doe may browse the Internet while being logged into his account and, upon selecting buttons 102a and 102b, the items “Palo Alto Movie Theatre” and “The Super Hero Movie” are added to a list of items of interest to John Doe.

In some embodiments, the user is provided an opportunity to indicate their level/degree of interest. For example, upon selecting button 102a, John Doe is prompted with the option of identifying “Palo Alto Movie Theatre” as an item of “High Interest”, “Moderate Interest” or “Low Interest” via selection of a corresponding one of pop-up buttons 104a, 104b or 104c. Where John Doe selects button 102a and button 104a, “Palo Alto Movie Theatre” is added to the list of items of interest to John Doe in association with a “High” level of interest.

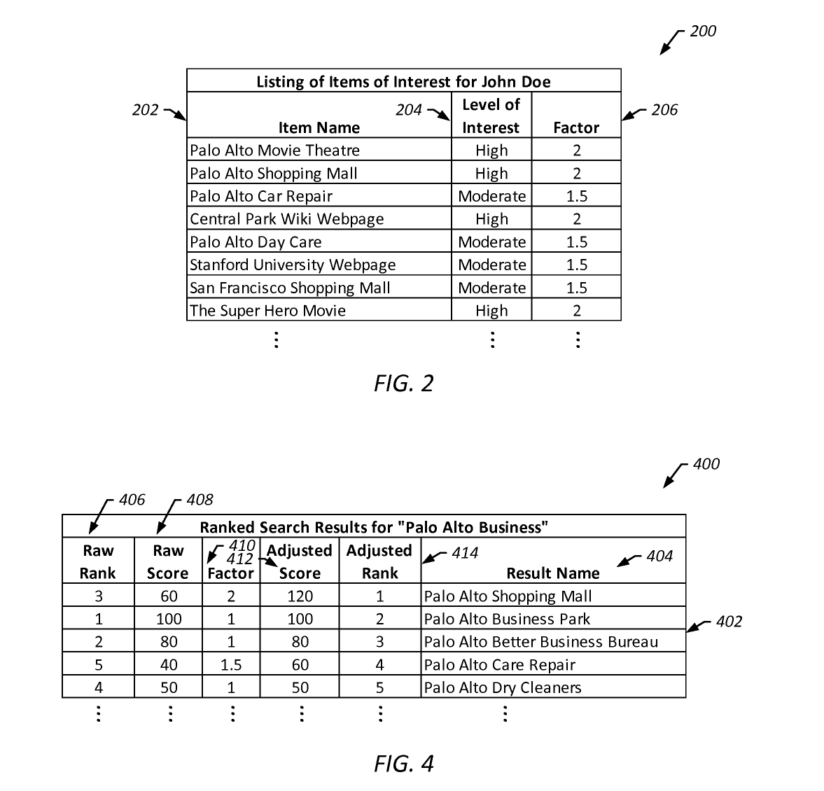

FIG. 2 is an illustration of a table 200 including an exemplary listing of items of interest 201 for John Doe. Each entry of table 200 corresponds to an item selected by John Doe and includes a name 202, a level of interest 204 and a factor 206. Name 202 includes a name/title or similar descriptive information for the item selected. Level of interest 204 corresponds to the user's level/degree of interest in the item. Factor 206 includes a factor that corresponds to the level of interest 204. For example, where John Doe selects button 102a on the place page for “Palo Alto Movie Theatre” and button 104a indicating a high level of interest, the first entry of table 200, including the name “Palo Alto Movie Theatre” and “High” level of interest, is created. In some embodiments, factor 206 may include a predetermined factor that corresponds to the level/degree of interest. For example, high, medium and low levels of interest may correspond to factors of “2.0”, “1.5” and “1.25”, respectively. Although the illustrated embodiment includes a single table/list that includes items of various levels/degrees of interest and corresponding factors, other embodiments may include separate tables/lists corresponding to levels/degrees of interest and/or the factors. For example, a first table/list associated with a factor of “2.0” and including all items selected as being of “High” interest, a second table/list associated with a factor of “1.5” and including all items selected as being of “Moderate” interest, and a third table/list associated with a factor of “1.25” and including all items selected as being of “Low” interest. The table(s) may be stored in a data repository (e.g., repository 610 described in more detail below). In some embodiments, all items of interest to a user may be associated with a given level/degree of interest. For example, upon the user may not be presented with the option to select a level/degree of interest, and items selected are associated with a default level/degree of interest and factor (e.g., moderate level/degree of interest and a factor of 1.5×).

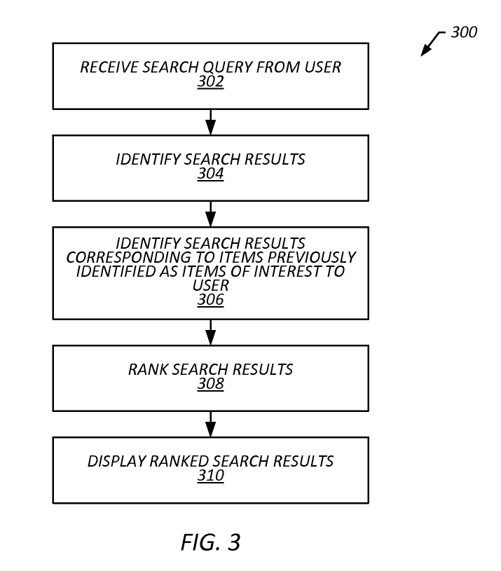

FIG. 3 is a flowchart that illustrates an exemplary method 300 of ranking and displaying search results. Method 300 includes receiving a search query from a user as depicted at block 302. Receiving a search query may include receiving a free-text search string via a search webpage, a map-based search via a search webpage, or the like. For example, John Doe may submit the search string “Palo Alto Business” via a free-text search field of a search webpage. In some embodiments, the search is associated with a particular user. For example, John Doe may submit the search query while being logged into his account.

Method 300 includes identifying search results as depicted at block 304. Identifying search results includes identifying a set of one or more search results that are responsive to the search query. For example, where John Doe submits a search query for “Palo Alto Business”, a corresponding search query is submitted to a search server (e.g., a search engine), and the search server processes the search query to identify a listing of search results (e.g., a listing of entities/webpages) corresponding to “Palo Alto Business”.

Method 300 includes identifying search results corresponding to items previously identified as items of interest to the user as depicted at block 306. In some embodiments, identifying search results corresponding to items previously identified as items of interest to the user includes assessing some or all of the search results to identify search results having a name that matches (e.g., is the same or similar to) a name in a list of items of interest to the user. For example, where the search results include “Palo Alto Shopping Mall” and “Palo Alto Car Repair”, at least these two results are identified as corresponding to items of interest to the user (John Doe) based on their presence in the “List of items of interest to John Doe” 200 (See FIG. 2).

Method 300 includes ranking search results as depicted at block 308. In some embodiments, ranking search results includes determining a ranking score for each of the search results identified at block 306 and raking the search results based on the raking score. The ranking score may be based on a raw raking score provided by the search engine and any applicable factors. The raw ranking for a search results (e.g., a webpage) may include a score determined by the search engine based any number and combination of factors, such as popularity, relevancy to the search query, and so forth. In some embodiments, search results are associated with a raw ranking score, and the raw ranking score for the search results corresponding to the items previously identified as items of interest to the user (identified at block 306) is multiplied by the factor corresponding thereto. For example, the raw ranking score corresponding to “Palo Alto Shopping Mall” is multiplied by “2” and the raw ranking score corresponding to “Palo Alto Car Repair” is multiplied by “1.5” in accordance with the factors 206 provided in the table of FIG. 2.

FIG. 4 is a table 400 that illustrates an exemplary set of ranked search results 402. Set of ranked search results 402 may include a listing of search results identified by a search engine in response to the search query for “Palo Alto Business” by John Doe. Each entry of table 400 corresponds to a given search result of set of search results 402. Each entry includes a result name 404, a raw ranking 406, a raw score 408, a factor 410, an adjusted score 412 and an adjusted rank 414. The raw ranking 406 is derived based on the raw scores 408 of the search results initially returned by the search engine (e.g., prior to any score adjustments for search results corresponding to items in John Doe's list 201). The adjusted score 412 is a product of raw score 408 and factor 410. The factors 410 for search results corresponding to items of interest to John Doe (i.e., items in list 201) include the factor listed in table 200. For example, the search result for “Palo Alto Shopping Mall” has a factor 410 of “2” and the search result for “Palo Alto Car Repair” has a factor 410 of “1.5” in accordance with the factors 206 provided in table 200 of FIG. 2. The factors 410 for search results that do not correspond to an item of interest to John Doe may have a default value (e.g., a value of “1”) or other value determined by the search engine. The adjusted rank 414 is based on the adjusted score 412, with those search results having the highest adjusted score 412 being ranked the highest. Notably, the search result for “Palo Alto Mall” moved from a raw ranking of “3” to an adjusted ranking of “1” based on the score adjustments. Further, the search result for “Palo Alto Car Repair” moved from a raw ranking of “5” to an adjusted ranking of “4” based on the score adjustments.

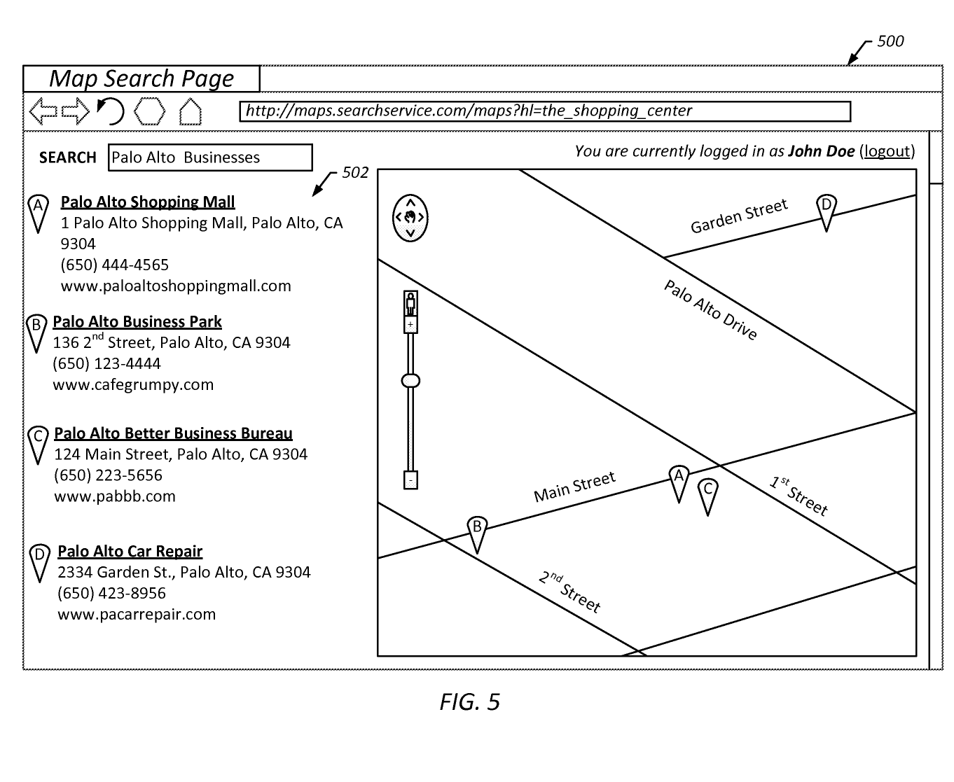

Method 300 includes displaying ranked search results as depicted at block 310. Displaying the ranked search results may include displaying a listing of search results in accordance with the adjusted rankings FIG. 5 is an illustration of an exemplary webpage 500 displaying map-based search results 502. Search results 502 correspond to set of search results 402 ranked based on their adjusted rank 414. Accordingly, the search results displayed reflect a boost in ranking score and/or ranking of search result that correspond to items previously selected by John Doe as items of interest. In some embodiments, search results that correspond to items of interest to the user may be accompanied by a graphic and/or annotations that communicate the association of the search result to the user's items of interest. For example, search results 502 for “Palo Alto Shopping Mall” and “Palo Alto Car Repair” may be highlighted, may be displayed with text having a color that is different from the search results for “Palo Alto Business Park”, and “Palo Alto Better Business Bureau”, and/or may be accompanied by an annotation adjacent the search result that states “This search result corresponds to one or your items of interest”. In some embodiments, the search results that receive a boost in score and/or ranking may be displayed in association with an indication of the boost in score and/or ranking. For example, search results 502 for “Palo Alto Shopping Mall” and “Palo Alto Car Repair” may be accompanied by an annotation adjacent the search result that states “This search result received a boost in ranking based on your indication that it a place of interest to you”.

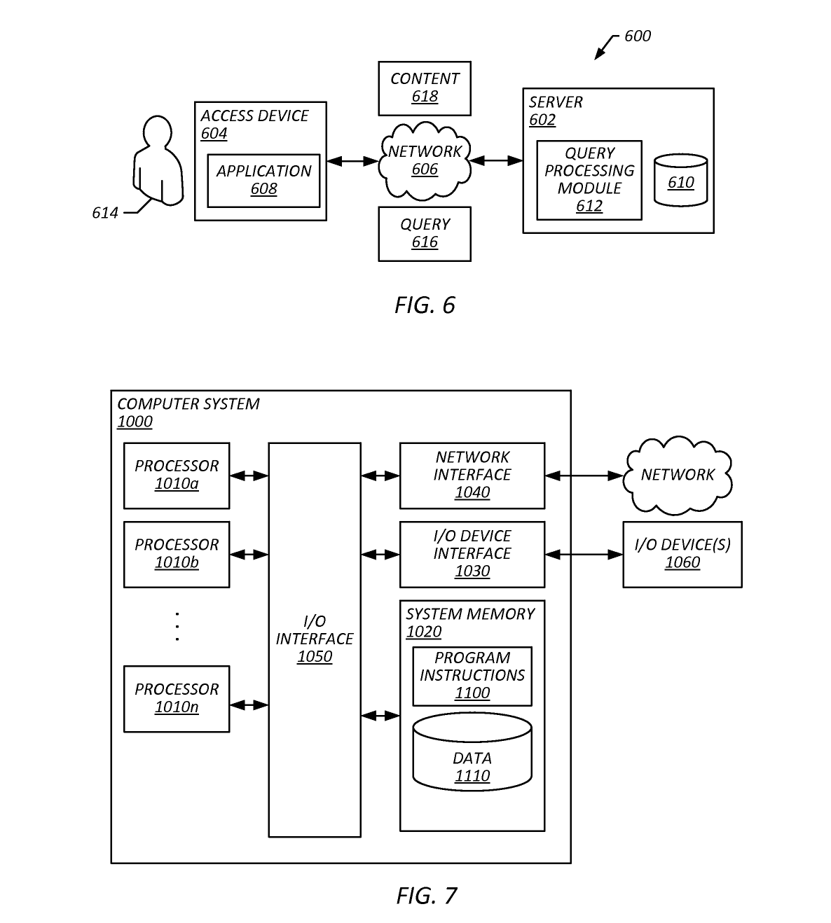

Method 300 is an exemplary embodiment of methods that may be employed in accordance with techniques described herein. Method 300 may be may be modified to facilitate variations of its implementations and uses. Method 300 may be implemented in software, hardware, or a combination thereof. Some or all of method 300 may be implemented by one or more of the modules/applications described herein, such as query processing module 612 or application 608 depicted and described in more detail below with regard to FIG. 6. The order of method 300 may be changed, and various elements may be added, reordered, combined, omitted, modified, etc.

FIG. 6 is a block diagram that illustrates an exemplary query environment 600. Environment 600 includes a server 602 and an access device 604 communicatively coupled via a network 606.

Network 606 may include an electronic communications network, such as the Internet, a local area network (LAN), a wide area (WAN), a cellular communications network or the like. In some embodiments, network 606 may include a single network or combination of networks.

Access device 604 may include a device capable of communicating information via network 606. For example, access device 604 may include a personal computer (e.g., a desktop computer), a mobile computing device (e.g., a laptop or tablet computer), a cellular communication device (e.g., a cellular phone), a personal digital assistant (PDA), or the like. In some embodiments, access device 604 may be client device of server 602. In some embodiments, access device 604 may include various input/output (I/O) interfaces, such as a graphical user interface (e.g., display screen), an audible output user interface (e.g., speaker), an audible input user interface (e.g., microphone), a keyboard, a pointer/selection device (e.g., mouse, trackball, touchpad, touchscreen, stylus or the like), a printer, or the like. In some embodiments, access device 604 may include general computing components and/or embedded systems optimized with specific components for performing specific tasks. In some embodiments, access device 604 may include a computer system similar to that of computer system 1000 described below with regard to at least FIG. 7.

In some embodiments, access device 604 includes programs/applications 608 that can be used to generate a request for content, to provide content, to render content, and/or to send/receive request to/from other devices via network 606, such as client applications used for communicating with server 602. For example, access device 604 may include Internet browser application that facilitates communication with server 602 and/or other entities of environment 600. In some embodiments, application 608 includes modules having program instructions that are executable by a computer system to perform some or all of the functionality described herein with regard to access device 604.

Server 602 may include a network entity that serves requests by client entities, such as requests by access device 604. Server 602 may host a content site, such as a website, a file transfer protocol (FTP) site, an Internet search website or other source of network content. In some embodiments, server 602 includes a search engine. In some embodiments, server 602 includes or otherwise has access to a datastore 610, such as a database or similar data repository. In some embodiments, server 602 includes a query processing module 612. Query processing module 612 may include program instructions that are executable by a computer system to perform some or all of the functionality described herein with regard to server 602. In some embodiments, server 602 includes a computer system similar to that of computer system 1000 described below with regard to at least FIG. 7. Although server 602 is represented by a single box in FIG. 6, server 602 may include a single server or similar system, or a plurality of servers and/or similar systems. For example, server 602 may include a plurality of different servers and/or similar systems that may be employed individually or in combination to perform some or all of the functionality described herein with regard to server 502.

In some embodiments environment 600 is used to employ techniques described herein. For example, a user 614 may select items of interest and/or submit a query 516 (e.g., a keyword or map-based search query for “Palo Alto Business”) via access device 604, server 602 may process the query and serve content 618 (e.g., search results webpage 500) to access device 604, and application 608 may render content 618 for display to user 614. In some embodiments, some or all of the processing of query 616 is provided by access device 604 and/or query processing module 612. For example, application 608 and/or query processing module 612 executes some or all of the processing described with regard to at least method 300.

Exemplary Computer System

FIG. 7 is a block diagram that illustrates an exemplary computer system 1000. Various portions of systems and methods described herein, may include or be executed on one or more computer systems similar to system 1. For example, server 602 and/or access device 604 may include a configuration similar to at least a portion of computer system 1000. Further, methods/processes/modules described herein (e.g., query processing module 612 and/or application 608) may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof, or the like. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium having program instructions stored thereon that are executable by a computer processor (e.g., one or more of processors 1010a-1010n) to cause some or all of the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 3020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

1. A computer-implemented method comprising:
receiving one or more places previously identified by a user as being of interest to the user, the one or more places being identified by the user designating the respective places as being of interest to the user with respective webpages each about the respective places;
receiving a search query associated with the user;
identifying a set of search results responsive to the search query;
identifying one or more search results of the set of search results that correspond to the one or more places previously identified by the user as being of interest to the user;
ranking, with a processor, the set of search results to generate a ranked set of search results, the ranking comprising boosting the rankings of the one or more search results that correspond to one or more places previously identified by the user as being of interest to the user; and
providing search result content for display via a graphical user interface, the search result content comprising the ranked set of search results.

2. The method of claim 1, where the one or more places previously identified by the user as being of interest to the user are associated with a factor, and wherein boosting the ranking of the one or more search results comprises multiplying scores associated with the one or more search results that correspond to the one or more places previously identified by the user as being of interest to the user by the factor.

3. The method of claim 1, where the one or more places previously identified by the user as being of interest to the user are associated with various levels of interest that are each associated with a factor, and wherein boosting the ranking of the one or more search results comprises multiplying the scores associated with the one or more search results that correspond to the one or more places previously identified by the user as being of interest to the user by a factor that corresponds to the level of interest associated with the places corresponding to the search result.

4. The method of claim 1, further comprising:
sending, to the user, at least one of the respective webpages, the at least one of the respective webpages being a place-page, the place-page being a webpage that includes information about a particular geographic place, the information including contact information for the particular geographic place, images relating to the particular geographic place, and reviews of the particular geographic place,
wherein the place-page includes a user-selectable button to add the particular geographic place to the one or more places previously identified by the user as being of interest to the user;
wherein receiving one or more places previously identified by a user as being of interest to the user comprises receiving an indication of selection of the particular geographic place by the user, the indication being caused by the user selecting the user-selectable button; and
adding the particular geographic place to the one or more places previously identified by the user as being of interest to the user by storing, in a data repository, an identifier of the particular geographic place.

5. The method of claim 1, comprising receiving an indication of selection of one or more places of interest by the user, wherein identifying one or more search results of the set of search results that correspond to one or more places previously identified by the user as being of interest to the user comprises:
identifying places corresponding to the search results; and
comparing the places identified to the listing of the one or more places of interest selected to identify one or more search results of the set of search results that correspond to one or more places previously identified by the user as being of interest to the user.

6. The method of claim 1, comprising receiving an indication of selection of one or more places of interest by the user, wherein receiving an indication of selection of one or more places of interest by the user comprises, for at least one of the places of interest, receiving indication of user selection of a graphic displayed in association with webpage content corresponding to the place.

7. The method of claim 1, comprising receiving an indication of selection of one or more places of interest by the user, wherein receiving an indication of selection of one or more places of interest by the user comprises receiving an indication of a level of interest in the one or more places of interest, wherein boosting the ranking of search results corresponding to the one or more places of interest is based on the level of interest in the one or more places of interest, and wherein storing a listing of the one or more places of interest selected comprises storing the one or more places of interest in association with the corresponding levels of interest.

8. The method of claim 1, wherein the place is a particular business.

9. The method of claim 1, wherein the search query is a web-based search query initiated by the user.

10. A system comprising:
one or more memories storing instructions; and
one or more processors coupled to the one or more memories and executing the instructions, the instructions being configured to cause the one or more processors to effect steps comprising:
receiving one or more places previously identified by a user as being of interest to the user, the one or more places being identified by the user designating the respective places as being of interest to the user with respective webpages each about the respective places;
receiving a search query associated with the user;
identifying a set of search results responsive to the search query;
identifying one or more search results of the set of search results that correspond to one or more places previously identified by the user as being of interest to the user;
ranking the set of search results to generate a ranked set of search results, the ranking comprising boosting the rankings of the one or more search results that correspond to the one or more places previously identified by the user as being of interest to the user; and
sending search result content for display in a graphical user interface via a network, the search result content comprising the ranked set of search results.

11. The system of claim 10, where the one or more places previously identified by the user as being of interest to the user are associated with a factor, and wherein boosting the ranking of the one or more search results comprises multiplying scores associated with the one or more search results that correspond to the one or more places previously identified by the user as being of interest to the user by the factor.

12. The system of claim 10, where the one or more places previously identified by the user as being of interest to the user are associated with various levels of interest that are each associated with a factor, and wherein boosting the ranking of the one or more search results comprises multiplying scores associated with the one or more search results that correspond to the one or more places previously identified by the user as being of interest to the user by a factor that correspond to the level of interest associated with the place corresponding to the search result.

13. The system of claim 10, the steps further comprising:
sending, to the user, at least one of the respective webpages, the at least one of the respective webpages being a place-page, the place-page being a webpage that includes information about a particular geographic place, the information including contact information for the particular geographic place, images relating to the particular geographic place, and reviews of the particular geographic place,
wherein the place-page includes a user-selectable button to add the particular geographic place to the one or more places previously identified by the user as being of interest to the user;
wherein receiving one or more places previously identified by a user as being of interest to the user comprises receiving an indication of selection of the particular geographic place, the indication being caused by the user selecting the user-selectable button by the user, the indication being caused by the user selecting the user-selectable button; and
adding the particular geographic place to the one or more places previously identified by the user as being of interest to the user by storing, in a data repository, an identifier of the particular geographic place.

14. The system of claim 10, comprising receiving an indication of selection of one or more places of interest by the user, wherein identifying one or more search results of the set of search results that correspond to one or more places previously identified by the user as being of interest to the user comprises:
identifying places corresponding to the search results; and
comparing the places identified to the listing of the one or more places of interest selected to identify one or more search results of the set of search results that correspond to one or more places previously identified by the user as being of interest to the user.

15. The system of claim 10, comprising receiving an indication of selection of one or more places of interest by the user, wherein receiving an indication of selection of one or more places of interest by the user comprises, for at least one of the places of interest, receiving indication of user selection of a graphic displayed in association with webpage content corresponding to the place.

16. The system of claim 10, comprising receiving an indication of selection of one or more places of interest by the user, wherein receiving an indication of selection of one or more places of interest by the user comprises receiving an indication of a level of interest in the one or more places of interest, wherein boosting the ranking of a search results corresponding to the one or more places of interest is based on the level of interest in the one or more places of interest, and wherein storing a listing of the one or more places of interest selected comprises storing the one or more places of interest in association with the corresponding levels of interest.

17. The system of claim 10, wherein the place is a particular business.

18. The system of claim 10, wherein the search query is a web-based search query initiated by the user.

19. A computer-implemented method comprising:
receiving one or more places previously identified by a user as being of interest to the user, the one or more places being identified by the user designating the respective places as being of interest to the user with respective webpages each about the respective places;
identifying one or more search results responsive to a search query that correspond to the one or more places previously identified by the user as being of interest to the user, the one or more places previously identified by the user as being of interest to the user being associated with a ranking factor;
ranking the set of search results to generate a ranked set of search results, the ranking comprising boosting the rankings of the one or more search results that correspond to one or more places previously identified by the user as being of interest to the user by multiplying scores associated with the one or more search results that correspond to the one or more places previously identified by the user as being of interest to the user by the factor; and
sending search result content to the user via a network, the search result content comprising the ranked set of search results.

20. The method of claim 19, comprising:
sending, to the user, at least one of the respective webpages, the at least one of the respective webpages being a place-page, the place-page being a webpage that includes information about a particular geographic place, the information including contact information for the particular geographic place, images relating to the particular geographic place, and reviews of the particular geographic place,
wherein the place-page includes a user-selectable button to add the particular geographic place to the one or more places previously identified by the user as being of interest to the user;
wherein receiving one or more places previously identified by a user as being of interest to the user comprises receiving an indication of selection of the particular geographic place by the user, the indication being caused by the user selecting the user-selectable button;
adding the particular geographic place to one or more places previously identified by the user as being of interest to the user by storing, in a data repository, an identifier of the particular geographic place.
